(19) United States
(12) Patent Application Publication
(10) Pub. No.: US 2007/0283805 A1
(43) Pub. Date: Dec. 13, 2007

(54) Hydraulic actuator for a servo of a gear change and corresponding method of fabrication

(76) Inventors: Marcello Lorenzoni, Bologna (IT); Nerio Mengoli, Casalecchio Di Reno (IT); Stefano Giorgini, Minerbio (IT)

Correspondence Address: Kenneth L. Sherman, Esq.;Myers Dawes Andras & Sherman, LLP, 11th Floor, 19900 MacArthur Blvd., Irvine, CA, 92612, US

(21) Appl. No.: 11/707,667

(22) Filed: Feb. 16, 2007

(30) Foreign Application Priority Data
Feb. 17, 2006 (EP) 06425097.0

(51) Int. Cl. F16H 47/00

(52) U.S. Cl. 92/136; 29/890.09

(57) ABSTRACT

Described herein is a hydraulic actuator for a servo of a gear change provided with a control shaft; the hydraulic actuator displaces the control shaft axially along a central axis thereof, is set in a position corresponding to an intermediate portion of the control shaft, and has two chambers, which are alternatively filled with a pressurized fluid, are traversed by the control shaft, and are separated from one another by a flange, which is fitted on the control shaft and defines a piston of the hydraulic actuator; the control shaft has at least one row of seats, which are uniformly distributed along a circumference and around the central axis of the control shaft; and the flange has at least one lateral lip, which is set above the row of seats and is deformed in a position corresponding to each seat in order to engage the seat.

The present invention relates to a hydraulic actuator for a servo of a gear change and to a corresponding method of fabrication.

### BACKGROUND OF THE INVENTION

There is an increasingly widespread use of servo-assisted gear changes, which are structurally similar to a manual gear change of a traditional type but for the fact that the clutch pedal and the gear lever operated by the driver are replaced by corresponding electrical or hydraulic servos. Using a manual servo-assisted gear change, the driver only has to issue the order to pass to a higher gear or else to a lower gear to a transmission control unit, and the transmission control unit autonomously carries out gear change by acting both on the engine and on the servos associated to the clutch and gear change.

An order for change of gear can be generated manually, i.e., following upon a command imparted by the driver, or else automatically, i.e., independently of the action of the driver. When the order for performing a change of gear is generated, the transmission control unit drives the clutch servo for opening the clutch so as to separate a primary shaft of the gear change mechanically from an engine shaft. At the same time, the transmission control unit acts on the engine control unit in order to reduce temporarily the driving torque supplied by the engine.

Once the transmission control unit has verified opening of the clutch, it drives the gear-change servo to disengage the gear currently engaged. When the transmission control unit has verified disengagement of the gear, it drives the gear-change servo for displacing the gear-change control shaft so as to enable engagement of the new gear. Once the transmission control unit has verified that the primary shaft has reached the desired position with respect to the secondary shaft, it drives the gear-change servo for engaging the new gear.

Finally, when the transmission control unit has verified engagement of the new gear, it drives the clutch servo for closing the clutch so as to render the primary shaft of the gear change and the engine shaft angularly fixed to one another. At the same time, the transmission control unit acts on the engine control unit for restoring the driving torque supplied by the engine.

Generally, the gear-change servo is of a hydraulic type and acts on a gear-change control shaft to impress on the control shaft both an axial displacement, i.e., along an axis of symmetry, for selecting the range of the gears, and a rotation about the axis of symmetry for engaging and disengaging the individual gears. Consequently, the gear-change servo comprises a first hydraulic actuator, mechanically coupled to the control shaft for axial displacement of the control shaft, and a second hydraulic actuator, mechanically coupled to the control shaft for rotating the control shaft.

In the first servos produced, the two hydraulic actuators were both directly coupled to the control shaft, and acted independently on the control shaft. However, said constructional solution is cumbersome; for said reason an alternative embodiment has been proposed, in which the first hydraulic actuator is directly coupled to the control shaft for displacing the control shaft axially, whilst the second hydraulic actuator is coupled to a cam engaged by a pin fixed to the control shaft so as to render the cam angularly fixed to a fixed frame. When the cam is angularly fixed to the fixed frame, then the axial displacement of the control shaft forces the control shaft to perform a rotation as a result of the mechanical coupling between the pin and the cam, whereas, when the cam is not angularly fixed to the fixed frame, then the axial displacement of the control shaft brings about a rotation of the cam and not of the control shaft.

It has been proposed to set the first hydraulic actuator around an intermediate portion of the control shaft. In this solution, the first hydraulic actuator has two chambers, which are alternatively filled with a pressurized fluid for displacing the control shaft axially in the two directions, are traversed by the control shaft, are set in series along the control shaft, and are separated from one another by a flange, which is fixed to the control shaft and defines a piston of the hydraulic actuator. In known hydraulic actuators, the flange is monolithic with the control shaft, and is obtained by milling the control shaft, which entails removal of material. However, said machining is particularly long and expensive, in so far as from a rough piece, more than 50% of the material must be removed to obtain the finished control shaft integrating the flange.

### SUMMARY OF THE INVENTION

The aim of the present invention is to provide a hydraulic actuator for a servo of a gear change and a corresponding method of fabrication which will be free from of the drawbacks described above and, in particular, will be simple and inexpensive to provide.

According to the present invention a hydraulic actuator for a servo of a gear change and a corresponding method of fabrication are provided according to what is recited in the attached claims.

### BRIEF DESCRIPTION OF THE DRAWINGS

The present invention will now be described with reference to the annexed plate of drawings, which illustrates a non-limiting example of embodiment thereof, and in which:

FIG. 1 is a schematic cross-sectional view, with parts removed for reasons of clarity, of a servo built in accordance with the present invention;

FIG. 2 is a view at an enlarged scale of a hydraulic actuator of the servo of FIG. 1;

FIG. 3 is a view at an enlarged scale of a detail of the hydraulic actuator of FIG. 2; and

FIG. 4 is an exploded perspective view of a further detail of the hydraulic actuator of FIG. 2.

### DETAILED DESCRIPTION OF THE INVENTION

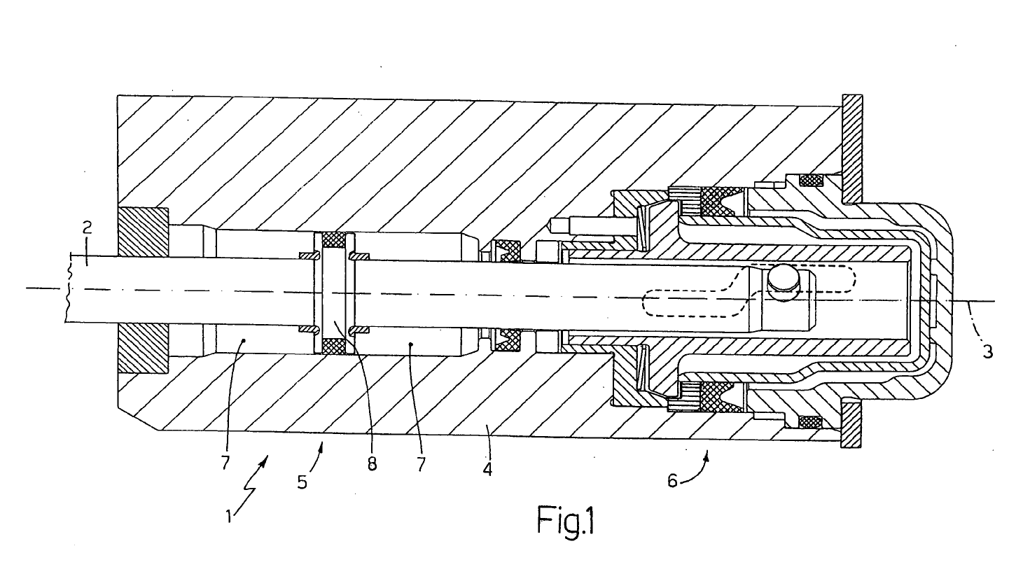

In FIG. 1, the reference number 1 designates as a whole a servo for a gear change, which is provided with a control shaft 2. The servo 1 acts on the control shaft 2 of the gear change to impress on the control shaft 2 both an axial displacement, i.e., along a central axis 3, for selecting the range of the gears, and a rotation about the central axis 3, for engaging and disengaging the individual gears. The servo 1 of the gear change comprises a fixed frame 4, which is traversed by the control shaft 2 and supports a first hydraulic actuator 5, mechanically coupled to the control shaft 2 for displacing the control shaft 2 axially, and a second hydraulic actuator 6, mechanically coupled to the control shaft 2 for rotating the control shaft 2 about the central axis 3.

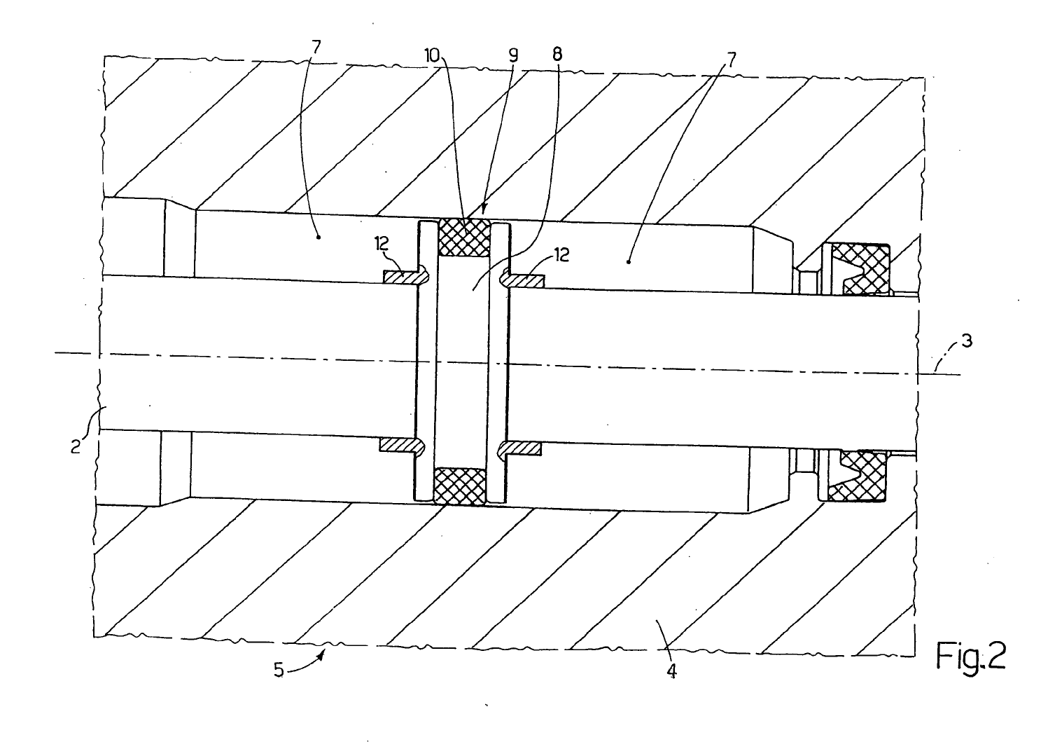

According to what is illustrated in FIG. 2, the first actuator 5 is set in a position corresponding to an intermediate portion of the control shaft 2 and has two chambers 7, which are alternatively filled with a pressurized fluid for displacing the control shaft 2 axially in the two directions under the control of a pair of solenoid valves (not illustrated). In particular, the two chambers 7 are traversed by the control shaft 2, are set in series along the control shaft 2, and are separated from one another by a flange 8, which is fixed to the control shaft 2 and defines a piston of the first hydraulic actuator 5. The flange 8 comprises a central annular cavity 9, which receives an annular seal gasket 10.

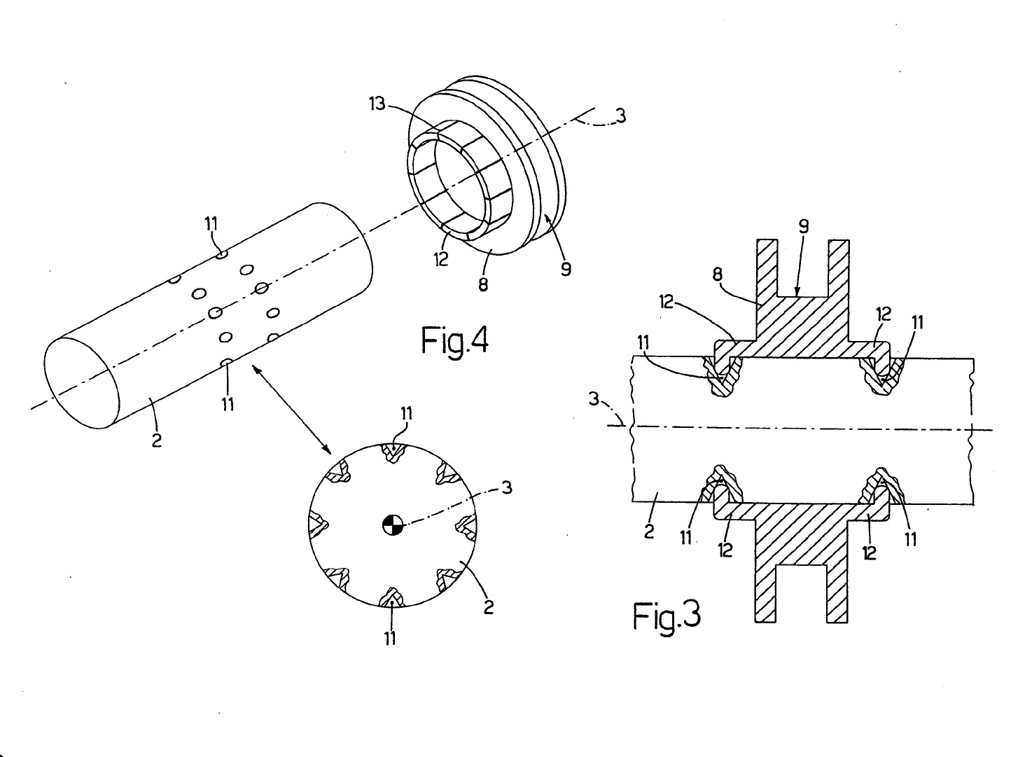

According to what is illustrated in FIGS. 3 and 4, the flange 8 is independent of the control shaft 2 and is fitted on the control shaft 2. In order to provide a sufficiently fixed mechanical connection between the flange 8 and the control shaft 2, the control shaft 2 comprises two rows of seats 11, which are uniformly distributed along respective circumferences and about the central axis 3 of the control shaft 2, and the flange 8 comprises a pair of lateral lips 12, each of which is set above a row of seats 11 and undergoes deformation in a position corresponding to each seat 11 in order to engage the seat 11. In particular, the two lateral lips 12 of the flange 8 are arranged on opposite sides of the flange 8 in a position corresponding to the respective rows of seats 11.

Preferably, each seat 11 has a triangular cross section (i.e., a conical shape) and each lateral lip 12 has notches 13 arranged parallel to the central axis 3 of the control shaft 2; the function of the notches 13 is to facilitate deformation of each lateral lip 12 preventing any splitting or in any case damage to the lateral lip 12.

According to a preferred embodiment, the control shaft 2 is made of a first material, and the flange 8 is made of a second material different from the first material and more malleable than the first material. For example, the first material could be steel, and the second material could be aluminium. Using two different materials for providing the control shaft 2 and the flange 8, it is to possible guarantee a high mechanical strength of the ensemble, at the same time simplifying construction of the ensemble.

According to a preferred embodiment, each lateral lip 12 has a thickness measured in a direction perpendicular to the central axis 3 of the control shaft 2 comprised between 0.5 and 1.0 mm and has a length measured in a direction parallel to the central axis 3 of the control shaft 2 comprised between 0.5 and 1.0 mm.

According to a different embodiment (not illustrated), the flange 8 comprises a single lip 12, and the control shaft 2 has a single row of seats 11.

From what has been set forth above, it is clear that, in order to provide the ensemble formed by the control shaft 2 and by the flange 8, the control shaft 2 is initially made separately from the flange 8, and the flange 8 is made separately from the control shaft 2 and is provided with the two lateral lips 12. Next, on the control shaft 2, the two rows of seats 11 are made, and then the flange 8 is fitted on the control shaft 2 so as to set each lateral lip 12 of the flange 8 above a row of seats 11 of the control shaft 2. Finally, each lateral lip 12 of the flange 8 is mechanically deformed in a position corresponding to each seat 11 in order to engage the seat 11.

The ensemble described above formed by the control shaft 2 and by the flange 8 is particularly fast and inexpensive to produce, in so far as removal of material by milling is reduced to the basic minimum. In fact, the control shaft 2 can be obtained using a rough piece having a diameter only slightly larger than the diameter of the finished control shaft 2 irrespective of the diameter of the flange 8. In addition, the system described above of mechanical connection between the control shaft 2 and the flange 8 is simple and fast to obtain and guarantees, at the same time, a high mechanical strength and a good constructional precision.

1) A hydraulic actuator (5) for a servo of a gear change provided with a control shaft (2); the hydraulic actuator (5) displacing the control shaft (2) axially along a central axis (3) thereof, being set in a position corresponding to an intermediate portion of the control shaft (2), and having two chambers (7), which are alternatively filled with a pressurized fluid for displacing the control shaft (2) axially in the two directions, are traversed by the control shaft (2), are set in series along the control shaft (2), and are separated from one another by a flange (8), which is fixed to the control shaft (2) and defines a piston of the hydraulic actuator (5); the hydraulic actuator (5) is characterized in that:
the flange (8) is independent of the control shaft (2) and is fitted on the control shaft (2);
the control shaft (2) comprises at least one row of seats (11), which are uniformly distributed along a circumference and around the central axis (3) of the control shaft (2); and
the flange (8) comprises at least one lateral lip (12), which is set above the row of seats (11) and is deformed in a position corresponding to each seat (11) in order to engage the seat (11).

2) The hydraulic actuator (5) according to claim 1, wherein the control shaft (2) comprises two rows of seats (11), and the flange (8) comprises two lateral lips (12), which are arranged on opposite sides of the flange (8) in a position corresponding to the respective rows of seats (11).

3) The hydraulic actuator (5) according to claim 1, wherein each seat (11) has a triangular cross section.

4) The hydraulic actuator (5) according to claim 1, wherein each lateral lip (12) has notches (13) arranged parallel to the central axis (3) of the control shaft (2).

5) The hydraulic actuator (5) according to claim 1, wherein the control shaft (2) is made of a first material and the flange (8) is made of a second material different from the first material.

6) The hydraulic actuator (5) according to claim 5, wherein the second material is more malleable than the first material.

7) The hydraulic actuator (5) according to claim 6, wherein the first material is steel and the second material is aluminium.

8) The hydraulic actuator (5) according to claim 1, wherein each lateral lip (12) has a thickness measured in a direction perpendicular to the central axis (3) of the control shaft (2) comprised between 0.5 and 1.0 mm and has a length measured in a direction parallel to the central axis (3) of the control shaft (2) comprised between 0.5 and 1.0 mm.

9) The hydraulic actuator (5) according to claim 1, wherein the flange (8) comprises a central annular cavity (9) designed to receive an annular seal gasket (10).

10) A method for production of a hydraulic actuator (5) for a servo of a gear change provided with a control shaft (2); the hydraulic actuator (5) displacing the control shaft (2) axially along a central axis (3) thereof, being set in a position corresponding to an intermediate portion of the control shaft (2), and having two chambers (7), which are alternatively filled with a pressurized fluid for displacing the control shaft (2) axially in the two directions, are traversed by the control shaft (2), are set in series along the control shaft (2), and are separated from one another by a flange (8), which is fixed to the control shaft (2) and defines a piston of the hydraulic actuator (5);
the method is characterized in that it comprises the steps of:
making the control shaft (2) separately from the flange (8);
making in the control shaft (2) at least one row of seats (11), which are uniformly distributed along a circumference and around the central axis (3) of the control shaft (2);
making the flange (8) separately from the control shaft (2) and providing it with at least one lateral lip (12);
fitting the flange (8) on the control shaft (2) so as to provide the lateral lip (12) of the flange (8) above the row of seats (11) of the control shaft (2); and
deforming the lateral lip (12) of the flange (8) in a position corresponding to each seat (11) in order to engage the seat (11).

11) The method according to claim 10, wherein the control shaft (2) comprises two rows of seats (11), and the flange (8) comprises two lateral lips (12), which are arranged on opposite sides of the flange (8) in a position corresponding to the respective rows of seats (11).

12) The method according to claim 10, wherein each seat (11) has a triangular cross section.

13) The method according to claim 10, wherein the control shaft (2) is made of a first material and the flange (8) is made of a second material different from the first material.

14) The method according to claim 13, wherein the second material is more malleable than the first material.

15) The method according to claim 14, wherein the first material is steel and the second material is aluminium.
